(19) United States
(12) Patent Application Publication
(10) Pub. No.: US 2009/0103063 A1
(43) Pub. Date: Apr. 23, 2009

(54) COOLING APPARATUS FOR OPTICAL MEMBER, BARREL, EXPOSURE APPARATUS, AND DEVICE MANUFACTURING METHOD

(76) Inventor: Jin Nishikawa, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/253,099

(22) Filed: Oct. 16, 2008

Related U.S. Application Data
(60) Provisional application No. 60/996,403, filed on Nov. 15, 2007.

(30) Foreign Application Priority Data
Oct. 18, 2007 (JP) 2007-271328

(51) Int. Cl. G03B 27/52; G03B 27/32

(52) U.S. Cl. 355/30; 355/77

(57) ABSTRACT

An optical member cooling apparatus for cooling an optical member such as a mirror. The optical member cooling apparatus includes a cooling member fixed to the rear surface of the mirror by an engagement mechanisms. The rear surface of the mirror and the contact surface of the cooling mirror have a high flatness. A locking portion including a groove and an extended portion is formed in the rear surface of the mirror. A shaft of the engagement mechanism is hooked to the extended portion of the locking portion. The engagement member is urged toward the cooling member by a spring.

### CROSS-REFERENCE TO RELATED APPLICATIONS

This application is based upon and claims the benefit of priority from prior Japanese Patent Application No. 2007-271328, filed on Oct. 18, 2007, and U.S. Provisional Application No. 60/996,403, filed on Nov. 15, 2007, the entire contents of which are incorporated herein by reference.

### BACKGROUND OF THE INVENTION

The present invention relates to an optical member cooling apparatus for cooling an optical member, such as a reflective optical element and a transmissive optical element. Further, the present invention relates to a barrel including at least one optical member. Additionally, the present invention relates to an exposure apparatus used in a process for manufacturing a device such as a semiconductor device, a liquid crystal display device, and a thin-film magnetic head, and a device manufacturing method using the exposure apparatus.

Due to the demand for semiconductor devices with higher integration, circuit patterns have become further miniaturized. Thus, in an exposure apparatus for manufacturing semiconductors, the exposure light that is used has been shifted to light of short wavelengths, such as ultraviolet light and far ultraviolet light. Further, exposure apparatuses using as the exposure light extreme ultraviolet light and soft X-ray with shorter wavelengths are being developed (for example, refer to Japanese Laid-Open Patent Publication No. 11-243052).

Recently, an extreme ultraviolet (EUV) exposure apparatus that is being developed uses light in the soft x-ray range of approximately 100 nm or less, or EUV light, as the exposure light. Presently, a practicable optical member that transmits EUV light does not exist. Therefore, in the EUV exposure apparatus, an illumination optical system and a projection optical system are formed by reflective optical elements (mirrors), and a mask that includes a circuit pattern is also formed by a reflective mask. However, the reflective optical elements of an illumination optical system and projection optical system cannot reflect all of the incident EUV light, and some of the incident EUV light is accumulated as heat energy in the reflective optical elements. The accumulated heat energy may thermally deform the reflective optical elements and decrease the surface accuracy of the reflection surfaces.

Accordingly, the present invention provides an optical member cooling apparatus and barrel that efficiently cools optical members. The present invention also provides an exposure apparatus and device manufacturing method that efficiently manufactures highly integrated devices.

To solve the above problem, an optical member cooling apparatus for cooling an optical member according to the present invention includes a cooling member including a contact surface which contacts a certain surface of the optical member. A fixing mechanism which fixes together the optical member and the cooling member in a state in which the certain surface and the contact surface of the cooling member are pressed against each other.

In this invention, the cooling member is fixed to the certain surface of the optical member in a state of contact while being pressed against the certain surface of the optical member. Thus, even if irradiation of the exposure light heats the optical member, heat conductance transfers the heat of the optical member to the cooling member. Accordingly, the optical member is cooled with extremely high efficiency.

Further, in an optical member cooling apparatus for cooling an optical member according to the present invention, the optical member cooling apparatus includes a heat transmission member including a heat absorption surface and a heat radiation surface and contacting the certain surface of the optical member with the heat absorption surface. A cooling member includes a contact surface which contacts the heat radiation surface of the heat transmission member. A fixing mechanism which fixes the heat transmission member and the cooling member to the optical member in a state in which the certain surface and the heat absorption surface are pressed against each other and the heat radiation surface and the contact surface are pressed against each other.

In this invention, the heat transmission member is fixed to an optical element in a state in which the heat absorption surface is pressed against the certain surface, and the cooling member is fixed to the optical element and the heat transmission member in a state in which the contact surface is pressed against the heat radiation surface. Thus, even if irradiation of the exposure light heats the optical member, heat conductance transfers the heat of the optical member to the heat transmission member. Further, the heat radiation surface of the heat transmission member that cools the optical member contacts the contact surface of the cooling member, and the cooling member cools the heat radiation surface in an optimal manner. Accordingly, the optical member is cooled with extremely high efficiency.

### BRIEF DESCRIPTION OF THE DRAWINGS

FIG. 1 is a schematic diagram showing an exposure apparatus in a first embodiment;

FIG. 2 is a diagram showing one example of an optical system barrel for an EUV exposure apparatus;

FIG. 3 is a perspective view showing a mirror of an optical system barrel and a cooling apparatus for the mirror in the first embodiment;

FIG. 4 is a plan view showing a rear surface of the mirror of FIG. 3;

FIG. 5 is a cross-sectional view taken along line 5-5 in FIG. 4;

FIG. 6 is a cross-sectional view showing a mirror and a cooling member in a state fixed by a fixing mechanism;

FIG. 7 is a cross-sectional view showing an engagement mechanism in an attached state;

FIG. 8 is a cross-sectional view showing an attachment jig in an attached state;

FIG. 9 is a cross-sectional view showing a state in which a shaft is moved to the attachment jig and joined with the mirror;

FIG. 10 is a cross-sectional view showing a state in which a tip portion of the shaft is fitted into a fitting portion of a locking portion;

FIG. 11 is a cross-sectional diagram showing a sate in which the attachment jig is removed;

FIG. 12 is a side view showing a mirror cooling apparatus in a second embodiment;

FIG. 13 is a schematic diagram showing the mirror cooling apparatus in the second embodiment;

FIG. 14 is a schematic diagram showing the mirror cooling apparatus in a third embodiment;

FIG. 15 is a schematic diagram showing a mirror cooling apparatus in a fourth embodiment;

FIG. 16 is a cross-sectional view showing part of a mirror cooling apparatus in the fourth embodiment;

FIG. 17 is a schematic diagram showing a mirror cooling apparatus in a fifth embodiment;

FIG. 18 is a perspective view showing a mirror cooling apparatus in a further embodiment;

FIG. 19 is a flowchart showing an example for manufacturing a device; and

FIG. 20 is a flowchart showing in detail substrate processing performed for a semiconductor device.

### DETAILED DESCRIPTION OF THE PREFERRED EMBODIMENTS

### First Embodiment

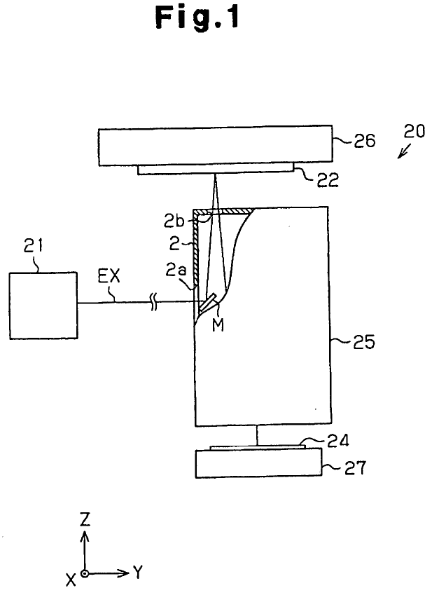

A first embodiment of the present invention will now be discussed with reference to FIGS. 1 to 11.

The first embodiment of an exposure apparatus, an optical member cooling apparatus, and a barrel according to the present invention are applied, for example, to an exposure apparatus for manufacturing a semiconductor device, a mirror cooling apparatus for cooling a mirror, and a barrel for accommodating an illumination optical system and will now be discussed. In this embodiment, an EUV exposure apparatus that uses extreme ultraviolet (EUV) light is used as the exposure apparatus.

FIG. 1 schematically shows the entire structure of an exposure apparatus 20 in this example. In the description hereafter, Z axis is parallel to the optical axis of a projection optical system 25, Y axis extends laterally along the plane of FIG. 1 that is orthogonal to the Z axis, and the X axis extends perpendicular to the plane of FIG. 1. While projecting part of a circuit pattern formed on a reticle 22, which serves as a mask, onto a wafer 24, which serves as an object or substrate, with the projection optical system 25, the exposure apparatus 20 uses a step and scan technique to scan the reticle 22 and the wafer 24 relative to the projection optical system 25 in a one-dimensional direction (here, the Y direction) and transfer the entire circuit pattern of the reticle 22 on each of a plurality of shot regions in the wafer 24.

The exposure apparatus includes an EUV light source 21, an illumination optical system (not shown), a reticle stage 26, a projection optical system 25, and a wafer stage 27. The EUV light source 21 emits light in the soft x-ray range, that is EUV light (extreme ultraviolet light) EX having a wavelength of approximately 100 nm or less, as exposure illumination light (exposure beam). The illumination optical system includes an optical path deflection mirror M, which reflects the EUV light EX from the EUV light source 21 so that the EUV light EX enters a pattern surface (lower surface) of the reticle 22 at a predetermined incident angle. The reticle stage 26 holds the reticle 22. The projection optical system 25 irradiates an exposed surface (upper surface) of the wafer 24 with the EUV light EX reflected by the pattern surface of the reticle 22. The wafer stage 27 holds the wafer 24. The mirror M is formed by a planar mirror and arranged in a barrel 2 of the projection optical system 25 but is actually part of the illumination optical system. A laser excitation plasma light source is used as one example of the EUV light source 21. EUV light mainly having a wavelength of 5 to 20 nm, for example, a wavelength of 13.5 nm, is used as one example of the EUV light EX. To prevent the EUV light EX from being absorbed by gas, the exposure apparatus 20 is accommodated in a vacuum chamber (not shown).

The illumination optical system includes a plurality of illumination mirrors and a waveform selection window (none shown) in addition to the mirror M. The EUV light EX emitted from the EUV light source 21 and reflected by the mirror, which is located at one end of the illumination optical system, illuminates part of the pattern of the reticle 22 in an arcuate slit-like manner.

An electrostatic chuck type (or mechanical chuck type) reticle holder (not shown) is arranged at the lower side of the reticle stage 26 to hold the reticle 22. A reflective reticle, which uses EUV light as illumination light, is used as the reticle 22. The reticle 22 is formed by a thin plate of a silicon wafer, quartz, low expansion glass, or the like. The reticle 22 has a pattern surface to which a reflective film for reflecting EUV light is applied. The reflective film is a multilayer film formed by alternately superimposing films of molybdenum and films of silicon Si so that the cycle between each set of a molybdenum film and silicon film is approximately 5.5 nm and the multilayer film includes about fifty sets of the molybdenum film and silicon film. The multilayer film has a reflectivity of approximately 70% with respect to EUV light having a wavelength of 13.5 nm. A multilayer film of the same structure is applied to the reflection surface of the mirror M and each of the other mirrors in the illumination optical system and the projection optical system 25. Nickel Ni or aluminum Al, for example, are applied as an absorption layer to the entire surface of the multilayer, which is formed on the pattern surface of the reticle 22. The absorption layer is patterned to form a circuit pattern serving as a reflection portion. The EUV light EX reflected by the circuit pattern is directed toward the projection optical system 25.

The projection optical system 25 has a numerical aperture of, for example, 0.3 and includes a reflective optical system that includes only reflective optical elements (mirrors). In this example, the projection magnification is ¼ times. The barrel 2 of the projection optical system 25 includes openings 2a and 2b for passage of the EUV light EX that strikes the mirror M and the EUV light EX striking and reflected by the reticle 22. The EUV light EX reflected by the reticle 22 travels through the projection optical system 25 and irradiates the wafer 24. The pattern of the reticle 22 reduced in size by ¼ and transfers the pattern of the reticle 22 on the wafer 24.

The wafer stage 27 has an upper surface on which an electrostatic chuck type wafer holder (not shown) is arranged to attract and hold the wafer 24.

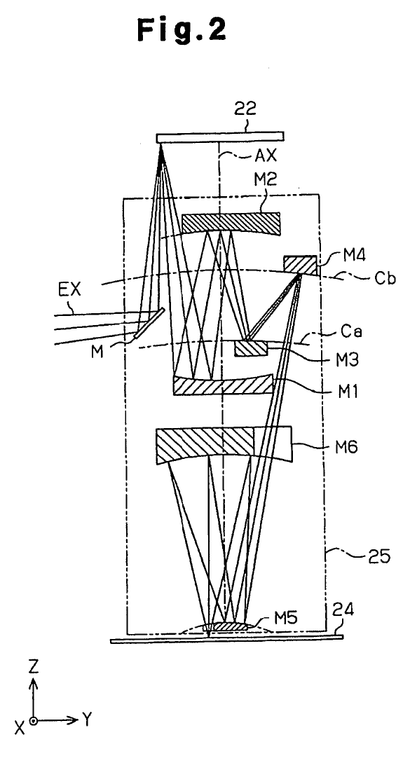

The projection optical system 25 will now be described in detail. FIG. 2 shows the layout of six mirrors M1 to M6, which serve as optical members that form the projection optical system 25. As shown in FIG. 2, from the reticle 22 toward the wafer 24, the mirror M2 is arranged with its reflection surface facing downward (−Z direction), the mirror M4 is arranged with its reflection surface facing downward, the mirror M3 is arranged with its reflection surface facing upward (+Z direction), the mirror M1 is arranged with its reflection surface facing upward, the mirror M6 is arranged with its reflection surface facing downward, and the mirror M5 is arranged with its reflection surface facing upward. The mirror M, which is part of the illumination optical system, is arranged between two extensions Ca and Cb, which are defined by extending the reflection surfaces of the mirrors M3 and M4. The reflection surface of each of the mirrors M1 to M6 is a rotation symmetric surface that is spheric or aspheric and includes a rotation symmetric axis substantially aligned with the optical axis AX of the projection optical system 25. The mirrors M1, M2, M4, and M6 are concave mirrors, and the mirrors M3 and M5 are convex mirrors. The reflection surfaces of the mirrors M1 to M6 are each machined to have a machining accuracy so that the reflection surface has a roughness of approximately one-fiftieth to one-sixtieth the exposure wavelength of the designed value and an evenness error of 0.2 nm to 0.3 nm as an RMS value (standard deviation). The reflection mirror of each mirror is formed by alternately performing measurements and machining to obtain the required shape.

In the structure of FIG. 2, the EUV light EX reflected by the reticle 22 is reflected upward by the mirror M1, reflected downward by the mirror M2, reflected upward by the mirror M3, and reflected downward by the mirror M4. Then, the EUV light EX reflected upward by the mirror M5 is reflected downward by the mirror M6 to form an image of a pattern of the reticle 22 on the wafer 24.

When exposing a single shot region on the wafer 24, the EUV light EX irradiates an illumination region of the reticle 22 with the illumination optical system. Further, the reticle 22 and the wafer 24 are moved in the Y direction relative to the projection optical system 25 at a velocity ratio that is in accordance with the reduction magnification of the projection optical system 25. Then, after driving the wafer stage 27 to step-move the wafer 24, the pattern of the reticle 22 undergoes scanning exposure for the next shot region on the wafer 24. The stepping movement and scanning exposure are repeated to expose a pattern of the reticle 22 onto a plurality of shot regions on the wafer 24.

As described above, the illumination optical system and the projection optical system 25 include a plurality of mirrors having multilayer films with a reflectivity of approximately 70%. Thus, the mirrors absorb some of the energy (the remaining approximately 30%) of the EUV light EX. The heat that is absorbed is several sub-watts to several watts and may thermally deform the mirror reflection surfaces and lower the imaging capability of the projection optical system 25.

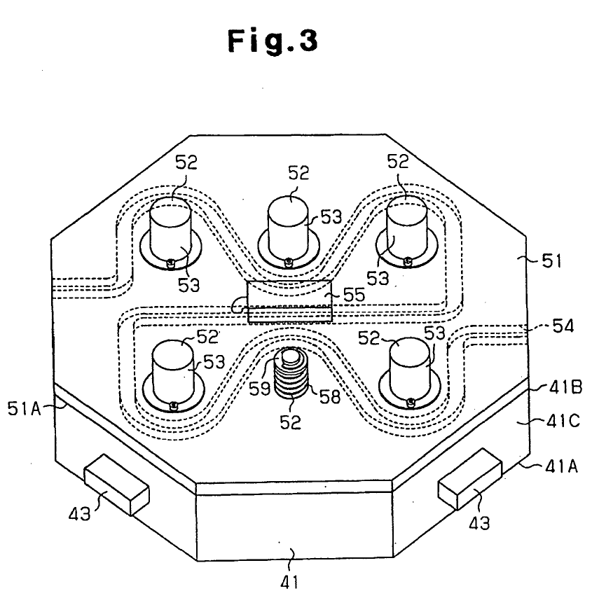

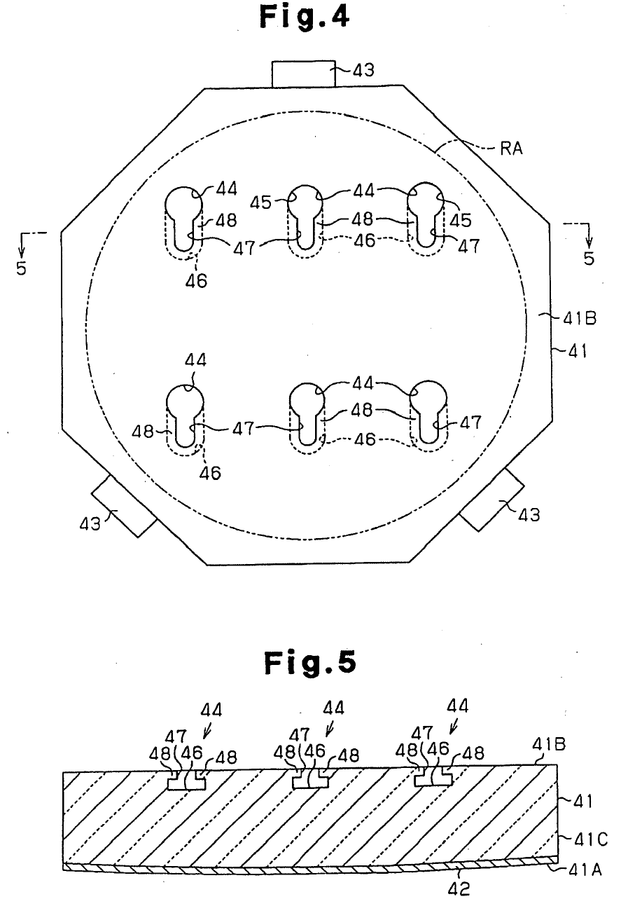

FIG. 3 is a diagram showing a mirror and a cooling apparatus for the mirror in an embodiment of the present invention. FIG. 4 is a plan view showing a certain surface (non-optical surface), and FIG. 5 is a cross-sectional view taken along line 5-5 in FIG. 5.

A mirror 41, which is described here, is one of the mirrors in the illumination optical system or the projection optical system 25. The mirror 41 shown in FIGS. 4 and 5 has a thickness of one to two centimeters and is generally octagonal. However, depending on the position the mirror 41 is arranged in the illumination optical system or the projection optical system 25, the mirror 41 may have a shape other than an octagon. For example, the mirror 41 may be circular, arcuate, or any polygon instead of being an octagon. In this embodiment, the mirror cooling apparatus may obviously be applied to a mirror having any type of shape.

The mirror 41 includes a reflection surface (incident surface) 41A, a surface opposite the reflection surface 41A, that is, a rear surface 41B defining the certain surface (non-optical surface), and a side surface 41C. When defining the reflection surface 41A as an optical surface, the rear surface 41B and side surface 41C are defined as non-optical surfaces. The mirror 41 is formed by a low thermal expansion glass, such as ZERODUR (registered trademark), and the reflection surface 41A is formed by an MO/Si multilayer 42. The rear surface 41B is polished to a level that is the same as an optical surface and has a high flatness.

The mirror 41 includes supports 43 formed at three locations on the side surface 14C spaced from one another in the circumferential direction. The supports 43 support the mirror 41 with support members (not shown) in the barrel 2.

As shown in FIG. 4, the rear surface 41B of the mirror 41 includes a plurality of (six in this embodiment) locking portions 44 corresponding to irradiation regions Ra of the EUV light EX on the reflection surface 41A. The locking portions 44 function as first engagement portions. Each locking portion 44 includes a groove 46, which extends in a predetermined direction and has a curvature at the two opposite ends, and an extended portion 48, which covers one end of the groove 46 and extends from the rim of the groove 46 toward the central part of the groove 46. The extended portion 48 forms a circular insertion hole 45 and an opening 47, which has a width that is larger than the diameter of the insertion hole 45. The other end of the groove 46 is exposed to form the insertion hole 45.

As shown in FIG. 3, a cooling member 51, which is planar and formed by a low thermal expansion steel, such as invar (registered trademark), or an alloy, is fixed to the rear surface 41B of the mirror 41 by engagement mechanisms 52, which will be described later. FIG. 3 shows a state in which a cover 53 is removed from one of the plurality of (six in this embodiment) engagement mechanisms 52. To increase the contact accuracy of the cooling member 51 and the mirror 41, that is, for perfect contact between a contact surface 51A of the cooling member 51 and a rear surface 41B of the mirror 41, it is desirable that each of the contact surfaces undergo planar processing. Preferably, a layer of a substance that is easier to machine than a low thermal expansion steel or alloy, such as a layer of nickel-phosphorous plating, is applied to the contact surface 51A of the cooling member 51 that contacts the mirror 41 and then mirror finishing is performed to increase the flatness of the contact surface 51A. In the same manner as the cooling member 51, a layer of a substance that is easier to machine than a low thermal expansion steel or alloy, such as a layer of nickel-phosphorous plating, may be applied to the rear surface 41B of the mirror 41. Then, mirror finishing is performed to increase the flatness of the contact surface 51A. The layer of an easily machined substance may be applied to only one of the rear surface 41B of the mirror 41 and the contact surface 51A of the cooling member 51.

A refrigerant passage 54, through which a refrigerant such as pure water circulates, meanders between the engagement mechanisms 52 in the cooling member 51. Further, the cooling member 51 includes a temperature sensor 55, which is located at an intermediate location between the inlet and the outlet of the refrigerant passage 54, that is at a position corresponding to a central portion in the rear surface 41B of the mirror, for detecting the temperature of the refrigerant flowing the intermediate location of the refrigerant passage 54. In this embodiment, the temperature of the refrigerant supplied to the refrigerant passage 54 is adjusted based on the detection result of the temperature sensor 55.

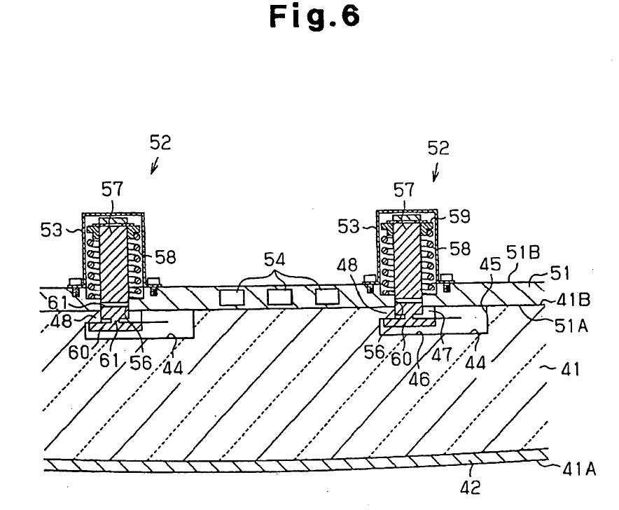

FIG. 6 is a cross-sectional view showing the mirror 41 and the cooling member 51 in a state fixed to each other by the engagement mechanisms 52. As shown in FIG. 6, through holes 56 extend through the cooling member 51 between the contact surface (interior surface) 51A and the opposite surface (exterior surface) 51B. The engagement mechanisms 52 are arranged in the cooling member 51 and function as second engagement portions. Each of the engagement mechanisms 52 is inserted into one of the through holes 56 in the cooling member 51 and includes a shaft 57 and a cover 53. The shaft 57 has an end to which a spring seat 59 is attached. The cover 53 covers the shaft 57 and a spring 58, which is arranged between the spring seat 59 and the surface 51B. The spring 58 produces biasing force for biasing the shaft 57 toward the surface 51B, which is opposite the contact surface 51A, and functions as a biasing member.

The shaft 57 has another end to which an engagement member 60 engaged with the circular insertion hole 45 in the rear surface 41B of the mirror 41 is attached by a flexure 61. The engagement member 60, which is disk-shaped and has a larger diameter than the shaft 57, engages the insertion hole 45, that is, the groove 46. Further, the shaft 57 has a diameter that is in correspondence with the width of the opening 47. In this embodiment, the locking portions 44 that function as the first engagement portions, the engagement mechanisms 52 that function as the second engagement, portions 52, and the springs 58 that function as biasing members form a fixing mechanism for fixing the mirror 41 to the cooling member 51.

When attaching the mirror 41 and the cooling member 51 with the fixing mechanism, the engagement member 60 is engaged with the corresponding insertion hole 45 in the rear surface 41B of the mirror 41. Then, by sliding the engagement member 60 from the insertion hole 45 toward the other end of the groove 46, the shaft 57 is moved along the opening 47 in the extended portion 48. That is, the shaft 57 is fitted to the extended portion 48. Accordingly, the extended portion 48 functions as a fitting portion to which the shaft 57 is fitted.

The biasing force of the spring 58 is transmitted to the extended portion 48 by the engagement member 60 of the shaft 57 so that the mirror 41 and the cooling member 51 are pressed against each other and fixed together.

The insertion holes 45 of the mirror 41 may each be formed to have a diameter that is larger than that of the engagement member 60 of the shaft 57.

The flexure 61 includes two necks formed at different positions in the axial direction of the shafts 57. The necks are formed by machining away the shaft 57 from opposite sides. The two necks are formed at different positions in the axial direction of the shaft 57 and machined in different directions. That is, one of the two necks is formed to extend in a predetermined direction, and the other one of the necks is formed to extend in a direction perpendicular to the predetermined direction. Due to the flexure 61, the engagement member 60 of the shaft 57 is inclinable along the surface of the groove 46 with the two necks functioning as rotary shafts.

The method for fixing the cooling member 51 to the mirror 41 will now be described with reference to FIGS. 6 to 11.

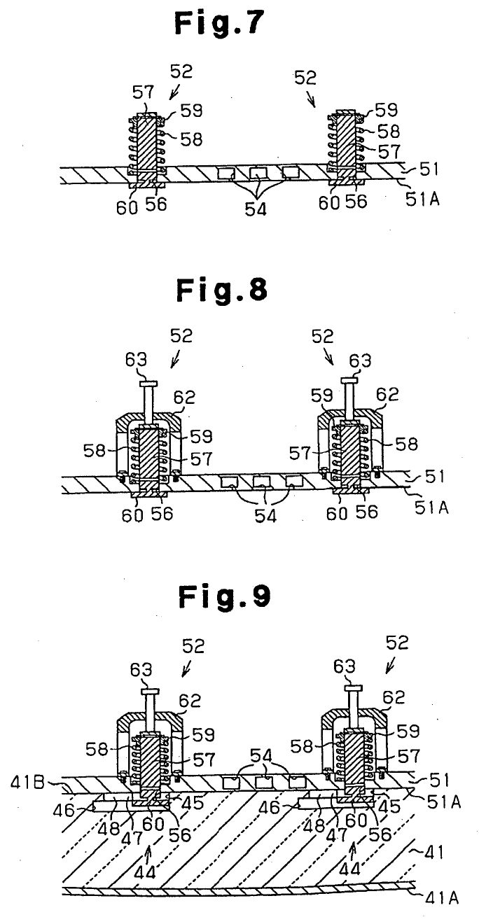

FIG. 7 is a cross-sectional diagram showing a state before the cooling member 51 is attached to the mirror 41. In this state, the engagement member 60 of the shaft 57 in each engagement mechanism 52 abuts against the contact surface 51A of the cooling member 51 due to the biasing force of the spring 58. Then, in this state, as shown in FIG. 8, attachment jigs 62, each having a reverse-U-shaped cross-section, are attached to the cooling member 51 so as to cover the shafts 57. Each attachment jig 62 includes a screw 63 contacting one end of the corresponding shaft 57 to move the shaft 57 so that the engagement member 60 is separated from the contact surface 51A.

Then, as shown in FIG. 9, the screw 63 of the attachment jig 62 is separated the engagement member 60 of the shaft 57 from the contact surface 51A of the cooling member 51 against the biasing force of the spring 58. The engagement member of the shaft 57 must be moved so as to form a gap from the contact surface 51A that is slightly greater than the thickness of the extended portion 48. Then, the contact surface 51A of the cooling member 51 is arranged facing toward the rear surface 41B of the mirror 41 so as to engage the engagement members 60 of the engagement mechanism 52 with the corresponding insertion holes 45.

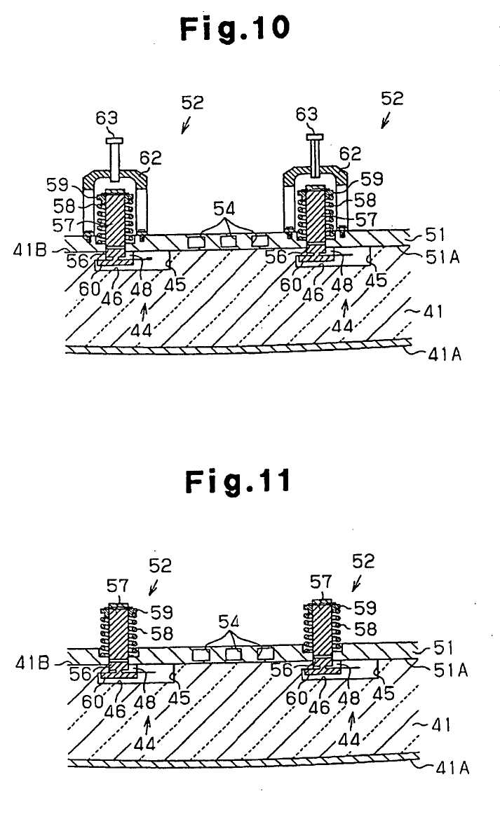

As shown in FIG. 10, after each engagement member 60 is engaged with the corresponding insertion hole 45, the cooling member 51 is moved parallel to the direction in which the groove 46 extends. This parallel movement moves the engagement member 60 along the groove 46 in a state in which the shaft 57 is fitted to the extended portion 48. The engagement member 60 is arranged between the bottom surface of the groove 46 and the extended portion 48. Then, the screw 63 of the attachment jig 62 is loosened so that the engagement member 60 of the shaft 57 contacts the extended portion 48. As a result, the biasing force of the spring 58 fixes together the mirror 41 and the cooling member 51 in a state pressed against each other. Then, as shown in FIG. 11, each attachment jig 62 is removed from the cooling member 51. Further, the covers 53 are attached to the cooling member 51 so as to cover the corresponding shafts 57, as shown in the state of FIG. 6.

The drawings show only two of the engagement mechanisms 52. When fixing the cooling member 51 to the mirror 41, the engagement mechanisms 52 may all be operated in the same manner.

This embodiment has the advantages described below.

(1) The mirror 41 includes a locking portion 44 for engaging the engagement mechanisms 52 on the cooling member 51 in a state in which the rear surface 41B and the contact surface 51A of the cooling member 51 are pressed against each other. This fixes the cooling member 51 in a state in which it is in direct contact with the rear surface 41B of the mirror 41. Thus, even if the irradiation of the EUV light EX heats the mirror 41, the heat of the mirror 41 is directly transferred to the cooling member 51 due to thermal conduction. This cools the mirror 41 in an extremely efficient manner. Accordingly, thermal deformation of the mirror 41 is effectively prevented even when using EUV light EX, which has a large amount of energy. This keeps a high surface accuracy for the reflection surface 41A of the mirror 41, and accurately transfers the pattern of the reticle 22 to the wafer 24.

(2) A metal layer, which is easier to machine than the material of the cooling member 51 is applied to the contact surface 51A of the cooling member 51. This easily improves the flatness of the contact surface 51A of the cooling member 51. Thus, the adhesiveness between the mirror 41 and the cooling member 51 is improved, and the cooling efficiency of the cooling member 51 is further increased. Further, this lowers the influence on the surface accuracy of the reflection surface 41A of the cooling member 51 when joining the cooling member 51 and the mirror 41.

(3) The mirror 41 and the cooling member 51 are fixed to each other by the engagement between the locking portions 44 of the mirror 41 and the engagement mechanisms 52 of the cooling member. Further, each engagement mechanism 52 includes a spring 58 for biasing the mirror 41 toward the cooling member 51. Thus, the mirror 41 and the cooling member 51 are fixed together in a state pressed against each other. Further, when, for example, the reflection surface 41A of the mirror 41 must be re-machined, the springs 58 may be flexed to remove the cooling member 51 from the mirror 41. Additionally, when re-attaching the cooling member 51 to the mirror 41, the pressing force can be reproduced.

(4) Each engagement mechanism 52 includes the engagement member 60, which has a large diameter, and the shaft 57, which has a smaller diameter than the engagement member 60. The rear surface 41B of the mirror 41 includes the grooves 46, which are engageable with the engagement members 60 of the engagement mechanisms 52 and extend in a predetermined direction, and the locking portions 44, which include the projections 48 that partially cover the grooves 46 and to which the shafts 57 are fittable. Thus, the cooling member 51 is fixed to the mirror 41 by inserting the shafts 57 of the engagement mechanisms 52 into the locking portions 44 and moving the engagement members 60 along the grooves 46.

(5) The engagement mechanisms 52 each include the flexure 61, which connects the engagement member 60 and the shaft 57. Thus, when the engagement mechanism 52 contacts the extended portion 48 of the corresponding locking portion 44, the extended portion 48 of the engagement member 60 comes into planar contact with the extended portion 48 without producing deformation caused by load. This lowers the influence of the fastening of the cooling member 51 to the mirror 41 on the surface accuracy of the reflection surface 41A.

(6) The rear surface 41B of the mirror 41 includes the plurality of locking portions 44 for locking the engagement mechanisms 52. Thus, the mirror 41 and the cooling member 51 uniformly come into contact with each other, and the cooling effect of the cooling member 51 is increased.

(7) The rear surface 41B of the mirror 41 includes the plurality of locking portions 44, which are located in a region that corresponds to the irradiation region RA of the reflection surface 41A onto which the EUV light EX is incident. Thus, in the region in which the mirror is easily heated, contact with the cooling member 51 is further ensured, and the mirror 41 is efficiently cooled.

(8) The cooling member 51 includes the refrigerant passage 54 to which the refrigerant is supplied so that the heat transmitted from the mirror 41 is readily released outside the cooling member 51.

(9) The cooling member 51 includes the temperature sensor 55, which detects the temperature of the refrigerant in the refrigerant passage 54. This obtains the temperature of the cooling member 51. Thus, by adjusting the temperature of the cooling member 51 based on the detection result of the temperature sensor 55, the temperature of the refrigerant to be supplied to the refrigerant passage 54 can be adjusted to ensure the cooling of the mirror 41.

(10) The mirror 41 is arranged in a vacuum atmosphere. Thus, it is difficult to sufficiently cool the mirror 41 when relying on radiation cooling. However, the mirror 41 is in direct contact with the cooling member 51 without any gaps. Accordingly, the transfer of heat from the mirror 41 to the cooling member 51 is performed in a further ensured and efficient manner, and the structure of the mirror 41 and the cooling member 51 is optimal for arrangement in a vacuum atmosphere.

(11) In the barrel 2 and the exposure apparatus 20, at least one mirror 41 is cooled by a mirror cooling apparatus having the afore-mentioned advantages (1) to (10). This effectively prevents thermal deformation of the mirror 41 and improves the exposure accuracy of the exposure apparatus 20.

The cooling member 51 of this embodiment is arranged on each mirror of the illumination optical system and the projection optical system 25. Further, it is preferred that temperature adjustment be performed for each mirror based on the temperature sensor arranged on the cooling member 51.

### Second Embodiment

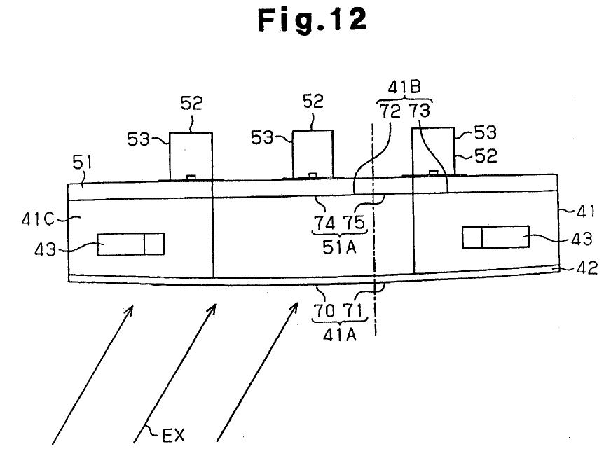

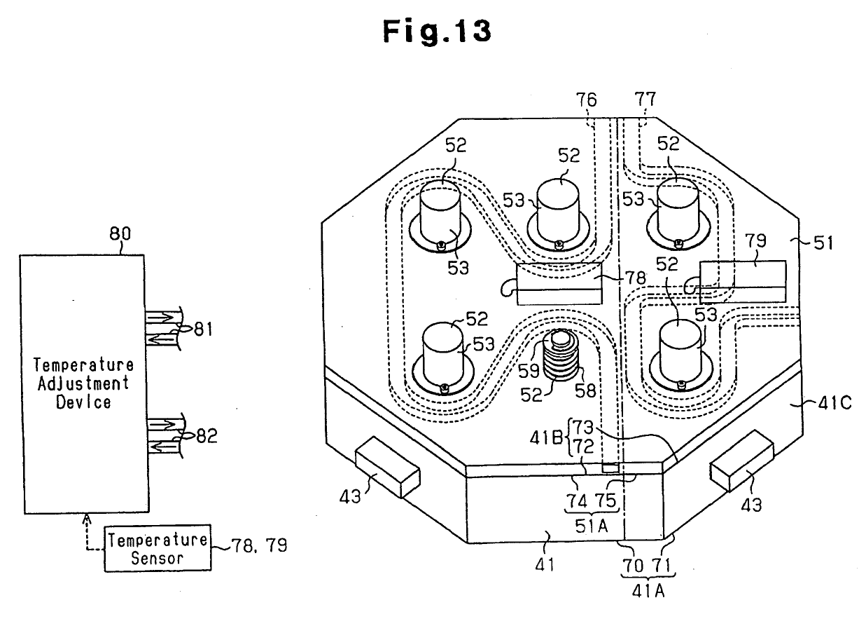

A second embodiment of the present invention will now be discussed with reference to FIGS. 12 and 13. In the second embodiment, the structure of the mirror cooling apparatus slightly differs from that of the first embodiment. Accordingly, in the description hereafter, parts differing from the first embodiment will be mainly described. To avoid redundancy, like or same reference numerals are given to those components that are the same as the corresponding components of the first embodiment.

As shown in FIG. 12, the EUV light EX may not entirely strike the reflection surface 41A of the mirror 41. In the illustrated example of FIG. 4, for example, the reflection surface 41A of the mirror 41 is symmetrically or evenly illuminated by the EUV light EX. In one embodiment, the reflection surface 41A of the mirror 41 may be asymmetrically or unevenly illuminated by the EUV light EX as illustrated in FIG. 12. More specifically, the reflection surface 41A of the mirror 41 may include an incident surface 70, which is located toward the left from a boundary line indicated by a broken line in FIG. 12 and which the EUV light EX strikes, and a non-incident surface, which is located toward the right from the boundary line indicated by the broken line in FIG. 12 and which the EUV light EX does not strike. When forming the incident surface 70 and the non-incident surface 71 on the reflection surface 41A in this manner, the accumulated amount of heat differs in the mirror 41 between an incident portion, which corresponds to the incident surface 70, and a non-incident portion, which corresponds to the non-incident surface 71. Thus, the mirror cooling apparatus of this embodiment is formed to have different cooling efficiencies for the incident portion and non-incident portion of the mirror 41. In the description hereafter, on the rear surface 41B defining the certain surface of the mirror 41, the region corresponding to the incident portion is referred to as a first surface 72 and the region corresponding to the non-incident portion is referred to as a second surface 73.

More specifically, as shown in FIG. 13, the mirror cooling apparatus includes a cooling member 51, which has a contact surface 51A that contacts the rear surface 41B of the mirror 41. In the contact surface 51A of the cooling member 51, the region that is contactable with the first surface 72 of the mirror 41 is referred to as a first contact surface 74, and the region that is contactable with the second surface 73 of the mirror 41 is referred to as a second contact surface 74. In the same manner as the first embodiment, a plurality of engagement mechanisms (six in this embodiment) fix the cooling member 51 to the mirror 41 in a state in which the contact surface 51A and the rear surface 41B are pressed against each other.

A plurality of (six in this embodiment) refrigerant passages 76 and 77 are formed in the cooling member 51. More specifically, the first refrigerant passage 76 is formed in the cooling member 51 at a portion corresponding to the first contact surface 74, and the second refrigerant passage 77 is formed in the cooling member 51 at a portion corresponding to the second contact surface 75. Further, the cooling member 51 includes a plurality of (two in this embodiment) temperature sensors 78 and 79 respectively corresponding to the refrigerant passages 76 and 77. The temperature sensor 78 for the first refrigerant passage 76 is located at a central part of the portion on the cooling member corresponding to the first contact surface 74 and arranged in a state in which the temperature of the first surface 72 of the cooling member 51 is detectable. The temperature sensor 79 for the second refrigerant passage 77 is located at a central part of the portion on the cooling member corresponding to the second contact surface 75 and arranged in a state in which the temperature of the second surface 73 of the cooling member 51 is detectable.

The mirror cooling apparatus includes a temperature adjustment device 80 coupled to the temperature sensors 78 and 79 which are capable of detecting the temperature of the first surface 72 and second surface 73 of the cooling member 51. The temperature adjustment device 80 receives electric signals from the temperature sensors 78 and 79 and adjusts the temperature of the refrigerant flowing through each of the refrigerant passages 76 and 77 based on the received signals. More specifically, the temperature adjustment device 80 adjusts the temperature of the refrigerant supplied to each of the refrigerant passages 76 and 77 so that the temperature of the first surface 72 and the temperature of the second surface 73 become equal. Further, the temperature adjustment device 80 supplies the refrigerant passages 76 and 77 with refrigerant through refrigerant supply pipes 81 and 82, respectively.

In the cooling member 51 of this embodiment, the accumulated amount of heat produced by heat energy is greater in the incident portion than in the non-incident portion. Thus, when uniformly cooling the cooling member 51, the temperature of the incident portion becomes higher than that of the non-incident portion and thereby produces an uneven temperature distribution in the mirror 41. In the first refrigerant passage 76, the temperature of the refrigerant circulated through the first refrigerant passage 76 is lower than the temperature of the refrigerant circulated through the second refrigerant passage 77.

Therefore, in the cooling member 51, the efficiency of the first contact surface 74 for cooling the incident portion of the mirror 41 is higher than the efficiency of the second contact surface 75 for cooling the non-incident portion of the mirror 41. As a result, the mirror cooling apparatus cools the mirror 41 without forming uneven temperature distribution on the mirror 41 even when an incident portion and non-incident portion are formed in the mirror 41.

In addition to advantages (1) to (11) of the first embodiment, this embodiment has the advantages described below.

(12) The mirror of this embodiment is formed so that the efficiency for cooling the incident portion of the mirror 41 is higher than the efficiency for cooling the non-incident portion. Thus, when cooling the mirror 41, which includes the incident portion and the non-incident portion, uneven temperature distribution in the mirror 41 is suppressed compared to when uniformly cooling the rear surface 41B of the mirror 41. This prevents the mirror 41 from being partially (for example, only the incident portion) deformed and keeps the reflection property of the mirror 41 in a satisfactory state.

### Third Embodiment

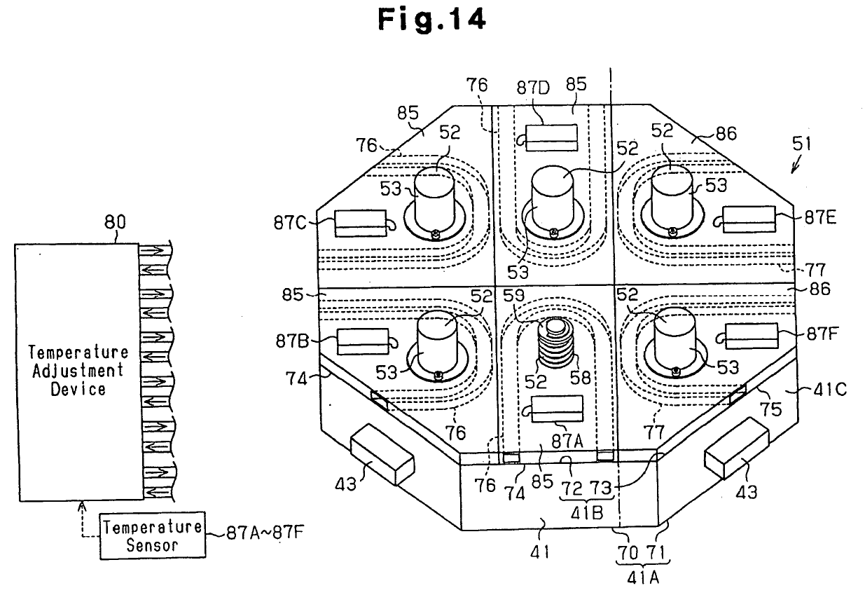

A third embodiment of the present invention will now be discussed with reference to FIG. 14. In the third embodiment, the structure of the mirror cooling apparatus slightly differs from that of the second embodiment. Accordingly, in the description hereafter, parts differing from the first and second embodiments will be mainly described. To avoid redundancy, like or same reference numerals are given to those components that are the same as the corresponding components of the first and second embodiments.

As shown in FIG. 14, the mirror cooling apparatus includes a cooling member 51, which comes into contact with the rear surface 41B of the mirror 41, and a temperature adjustment device 80, which adjusts the temperature of the cooling member 51. The cooling member 51 includes a plurality of (four in this embodiment) first cooling portions 85, each having a first contact surface 74 that comes into contact with the first surface 72 on the rear surface 41B of the mirror 41, and a plurality of (two in this embodiment) second cooling portions 86, each having a second contact surface 75 that comes into contact with the second surface 73.

The engagement mechanisms 52 fix the first cooling portions 85 and the second cooling portions 86 to the mirror 41 in a state in which the first contact surfaces 74 and second contact surfaces 75 are pressed against the first surfaces 72 and second surface 73 of the mirror 41. Further, the first cooling portions 85 and second cooling portions 86 include temperature sensors 87A, 87B, 87C, 87D, 87E, and 87F for detecting the temperatures of the first surface 72 and second surface 73. The temperature sensors 87A to 87F send electric signals to the temperature adjustment device 80 in correspondence with the temperatures of the first surface 72 and second surface 73.

Further, a first refrigerant passage 76 is formed in each of the first cooling portions 85 to circulate refrigerant for cooling the incident portion of the mirror 41 through the first cooling portion 85. Further, a second refrigerant passage 77 is formed in each of the second cooling portions 86 to circulate refrigerant for cooling the non-incident portion of the mirror 41 through the second cooling portion 86. The first refrigerant passages 76 and second refrigerant passage 77 are each supplied with refrigerant that has undergone temperature adjustment by the temperature adjustment device 80. Accordingly, in addition to advantages (1) to (12) of the first and second embodiments, this embodiment has the advantages described below.

(13) The cooling member 51 of this embodiment includes the cooling portions 85 and 86. In addition, the cooling portions 85 and 86 respectively include the refrigerant passages 76 and 77. This enables further fine temperature adjustment for each part of the mirror 41. Accordingly, temperature adjustment is performed in an optimal manner even if the accumulated amount of the heat energy differs between each portion of the mirror 41.

### Fourth Embodiment

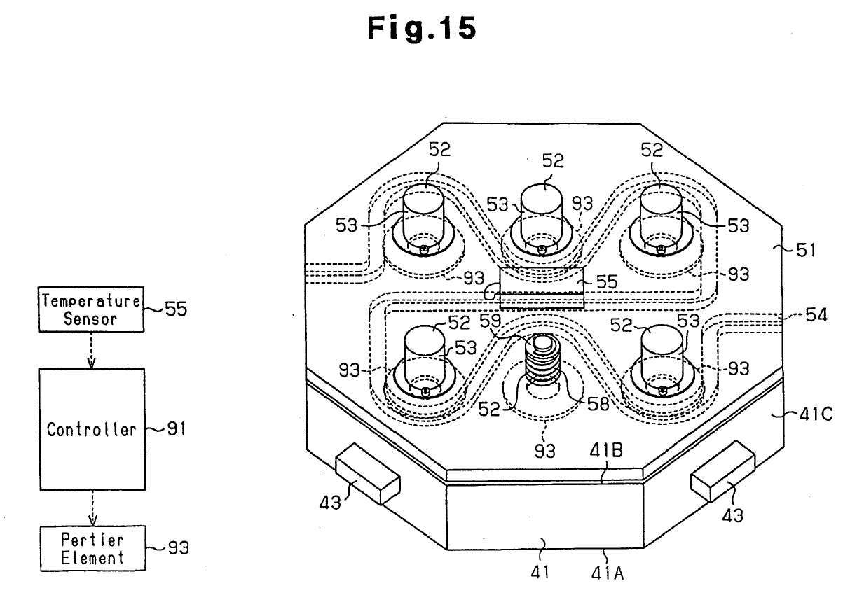

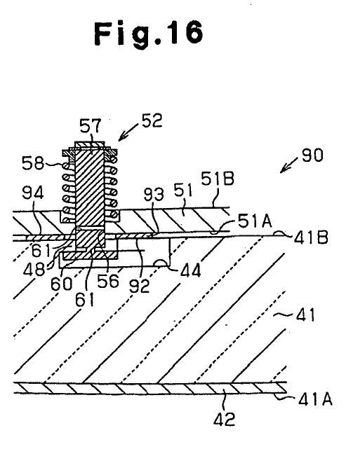

A fourth embodiment of the present invention will now be discussed with reference to FIGS. 15 and 16. In the fourth embodiment, the structure of the mirror cooling apparatus slightly differs from those of the first to third embodiments. Accordingly, in the description hereafter, parts differing from the first to third embodiments will be mainly described. To avoid redundancy, like or same reference numerals are given to those components that are the same as the corresponding components of the first to third embodiments.

Referring to FIG. 15, the mirror cooling apparatus of this embodiment includes a cooling mechanism 90, which is fixed to the rear surface 41B of the mirror 41, and a controller 91, which controls the cooling mechanism 90. As shown in FIGS. 15 and 16, the cooling mechanism 90 includes a plurality of (six in this embodiment) of Pertier elements 93, each having a heat absorption surface 92 that comes into contact with the rear surface 41B serving as the certain surface of the mirror 41, and a cooling member 51, which has a contact surface 51A that comes into contact with a heat radiation surface 94 of each Pertier element 93. The engagement mechanisms 52, the quantity of which is the same as that of the Pertier elements 93 (six in this embodiment), fix the Pertier elements 93 and the cooling member 51 to the mirror 411n a state in which the heat absorption surfaces 92 and the rear surface 41B are pressed against each other and the heat radiation surfaces 94 and the contact surface 51A are pressed against each other.

The Pertier elements 93 are each annular and arranged to surround the shaft 57 of the corresponding engagement mechanism 52. That is, each Pertier element 93 is arranged at a position where the pressing force applied by the corresponding engagement mechanism 52 is strongest. A refrigerant passage 54 through which refrigerant for cooling the heat radiation surfaces 94 of the Pertier elements 93 circulates is formed in the cooling member 51.

In this embodiment, it is desirable that the heat absorption surface 92 and heat radiation surface 94 of each Pertier element 93 undergo planar machining to increase the contact accuracy of the mirror 41 and the cooling member 51. Preferably, a layer of a substance that is easier to machine than a low thermal expansion steel or alloy, such as a layer of nickel-phosphorous plating, is applied to the heat absorption surface 92 and heat radiation surface 94 of each Pertier element 93. Then, mirror finishing is performed to increase the flatness of the heat absorption surface 92 and heat radiation surface 94. In the same manner as the cooling member 51, preferably, a layer of a substance that is easier to machine than a low thermal expansion steel or alloy, such as a layer of nickel-phosphorous plating, is applied to the rear surface 41B of the mirror 41 and the contact surface 51A of the cooling member 51 and then mirror finishing is performed to increase the flatness of the rear surface 41B of the mirror 41 and the contact surface 51A.

The cooling mechanism 90 includes a temperature sensor 55, which is located at a position corresponding to a central portion in the rear surface 41B of the mirror, for detecting the temperature of the rear surface 41B of the mirror 41. The temperature sensor 55 sends an electric signal, which corresponds to the temperature of the rear surface 41B of the mirror 41, to the controller 91.

The controller 91 includes a digital computer, which incorporates a CPU, ROM, and RAM. Based on the electric signal from the temperature sensor 55, the controller 91 performs computations to determine the temperature of the rear surface 41B of the mirror 41 and controls the efficiency for cooling the mirror 41 with the Pertier elements 93 in accordance with the determination. This embodiment differs from each of the above embodiments in that the mirror 41 is cooled by the Pertier elements 93, and the cooling member 51 cools the heat radiation surfaces of the Pertier elements 93. In such a structure, the mirror 41 is cooled in an optimal manner by the mirror cooling apparatus.

Accordingly, in addition to advantages (3) to (8) of the first to third embodiments, this embodiment has the advantages described below.

(14) The mirror 41 includes a locking portion 44 for engaging the engagement mechanisms 52 on the cooling member 51 in a state in which the rear surface 41B and the heat absorption surface 92 of each Pertier element 93 are pressed against each other and the heat radiation surface 94 of each Pertier element 93 and the contact surface 51A of the cooling member 51 are pressed against each other. This fixes the Pertier elements 93 in a state in which each of their heat absorption surfaces 92 is in direct contact with the rear surface 41B of the mirror 41. Thus, even if the irradiation of the EUV light EX heats the mirror 41, the heat of the mirror 41 is transferred to the cooling member 51 via the Pertier elements 93 due to thermal conduction. This cools the mirror 41 in an extremely efficient manner. Accordingly, thermal deformation of the mirror 41 is effectively prevented even when using EUV light EX, which has a large amount of energy. This keeps a high surface accuracy for the reflection surface 41A of the mirror 41 and accurately transfers the pattern of the reticle 22 to the wafer 24.

(15) The rear surface 41B of the mirror 41 and the heat absorption surface 92 of each Pertier element 93 undergo planar machining to increase the contact accuracy of the mirror 41 and the cooling member 51. This improves the adhesiveness of the heat radiation surface of each Pertier element 93 and the mirror 41 and further increases the cooling efficiency of the Pertier element 93.

(16) The heat radiation surface 94 of each Pertier element 93 and the contact surface 51A of the cooling member 51 mirror 41 undergo planar machining to increase the contact accuracy of the Pertier element 93 and the cooling member 51. This improves the adhesiveness of the heat radiation surface 94 of each Pertier element 93 and the cooling member 51 and further increases the efficiency for absorbing heat from the Pertier elements 93 with the cooling member 51.

(17) Each Pertier element 93 is arranged at a position where the pressing force applied by the corresponding engagement mechanism 52 is strongest. Thus, in comparison with when each Pertier element 93 is arranged at a position separated from the corresponding engagement mechanism 52, the adhesiveness of the Pertier element 93 and the mirror 41 is increased. This increases the efficiency for cooling the mirror 41.

(18) Typically, Pertier elements involves greater shape errors compared to mirrors due to machining accuracy. It is difficult to obtain a plurality of Pertier elements having equal thickness or height with high accuracy. Thus, when fixing the Pertier elements 93 or the cooling member 51 to the mirror 41 with just one engagement mechanism 52, a Pertier element 93 may have low adhesiveness with respect to the mirror 41 or cooling member 51. In such a case, the mirror 41 may not be cooled in an optimal manner. In this aspect, this embodiment provides the engagement mechanism 52 for each Pertier element 93. This ensures that each Pertier element 93 comes into contact with the mirror 41 and the cooling member 51 regardless of the errors in the shape of the Pertier element 93. Thus, each Pertier element 93 sufficiently exhibits its heat absorption property.

(19) The mirror 41 is arranged in a vacuum atmosphere. Thus, if is difficult to sufficiently cool the mirror 41 when relying on radiation cooling. However, the mirror 41 is in direct contact with the heat absorption surfaces 92 of the Pertier elements 93 without any gaps. Accordingly, the transfer of heat from the mirror 41 to the cooling member 51 via the Pertier elements 93 is performed in a further ensured and efficient manner, and the structure of the mirror 41, the Pertier elements 93 serving as heat transmission members, and the cooling member 51 is optimal for arrangement in a vacuum atmosphere.

### Fifth Embodiment

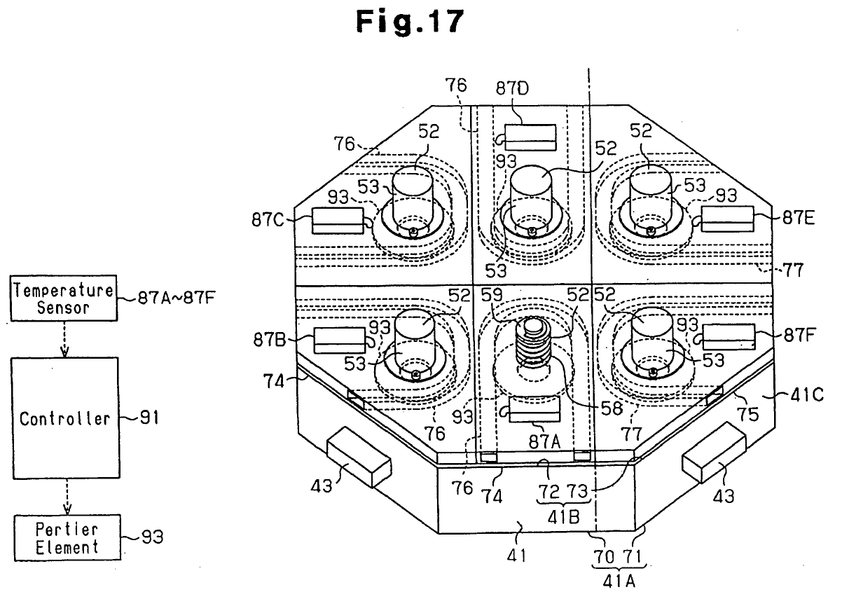

A fifth embodiment of the present invention will now be discussed with reference to FIG. 17. In the fifth embodiment, the structure of the mirror member slightly differs from that of the fourth embodiment. Accordingly, in the description hereafter, parts differing from the first to fourth embodiments will be mainly described. To avoid redundancy, like or same reference numerals are given to those components that are the same as the corresponding components of the first to fourth embodiments.

As discussed above, the reflection surface 41A of the mirror 41 may include an incident surface 70, which the EUV light EX strikes, and a non-incident surface, which the EUV light EX does not strike. It is preferable that the mirror cooling apparatus for cooling such a mirror 41 is formed to have different cooling efficiencies for the incident portion and non-incident portion of the mirror 41.

More specifically, as shown in FIG. 17, the cooling member 51 of this embodiment includes a plurality of (four in this embodiment) of first cooling portions 85, which cool the incident portion of the mirror 41, and a plurality of (two in this embodiment) second cooling portions 86, which cool the non-incident portion of the mirror 41. The first cooling portions 85 and the second cooling portions 86 respectively include refrigerant passages 76 and 77, through which refrigerant for cooling the heat radiation surfaces 94 of the Pertier elements 93 is circulated.

Each first cooling portion 85 includes a first contact surface 74, which comes into contact with the heat radiation surface 94 of the Pertier element 93 (first heat transmission member) having a heat absorption surface 92 that contacts the first surface 72. Each second cooling portion 86 includes a second contact surface 75, which comes into contact with the heat radiation surface 94 of the Pertier element 93 (second heat transmission member) having a heat absorption surface 92 that contacts the second surface 73. Further, the engagement mechanisms 52 fix the first cooling portions 85 and the second cooling portions 86 together with the Pertier elements 93 to the mirror 41. Additionally, the first cooling portions 85 include temperature sensors 87A, 87B, 87C, and 87D for detecting the temperature of the first surface 72, and the second cooling portions 86 include temperature sensors 87E and 87F for detecting the temperature of the second surface 73. The controller 91 independently controls each Pertier element 93 based on the temperature determined from the electric signals of the temperature sensors 87A to 87F.

Accordingly, in addition to advantages (3) to (8) and (14) to (19), this embodiment has the advantages described below.

(20) In this embodiment, each of the cooling portions 85 and 86 is provided with the Pertier element 93. This keeps the efficiency for cooling the mirror 41 with the Pertier elements 93 in a satisfactory state.

(21) Further, each Pertier element 93 is independently controlled in accordance with an electric signal from the corresponding one of the temperature sensors 87A to 87F. Thus, uneven temperature distribution in the mirror 41 is suppressed in comparison with when controlling the Pertier elements 93 with just one temperature sensor.

Each of the above embodiments may be modified as described below.

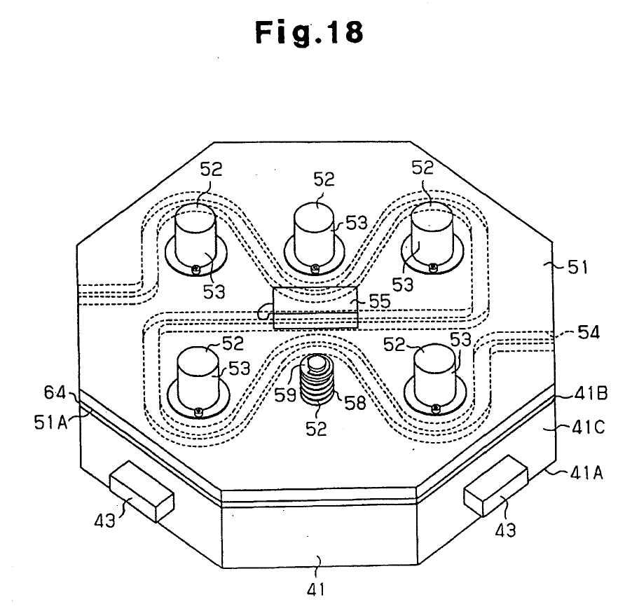

In FIG. 3, the mirror 41 directly contacts the cooling member 51. However, as show in FIG. 18, a soft metal layer 64 formed by a soft heat transmission substance such as indium or an alloy thereof may be formed between the mirror 41 and the cooling member 51 so that the mirror 41 and the cooling member 51 come into contact by means of the soft metal layer 64. Further, liquid metal having high thermal conductance (for example, liquid metal including gallium or indium) may be used as the soft thermal conductance substance. In such a structure, deformation of the soft metal layer 64 absorbs fine pits and lands in the rear surface 41B of the mirror 41 and the contact surface 51A of the cooling member 51. This ensures contact without the need for performing accurate planar machining of the rear surface 41B of the mirror 41 and the contact surface 51A of the cooling member 51.

In the same manner, in the second and third embodiments, a soft metal layer 64 formed by a soft heat transmission substance such as indium or an alloy thereof may be formed between the mirror 41 and the cooling member 51 so that the mirror 41 and the cooling member 51 come into contact by means of the soft metal layer 64. Further, liquid metal having high thermal conductance may be used as the soft thermal conductance substance.

In the same manner, in the fourth and fifth embodiments, a soft metal layer formed by a soft heat transmission substance such as indium or an alloy thereof may be formed between the mirror 41 and the Pertier elements 93 so that the mirror 41 and the Pertier elements 93 come into contact by means of the soft metal layer. Further, soft metal layer formed by a soft heat transmission substance such as indium or an alloy thereof may be formed between the Pertier elements 93 and the cooling member 51 so that the Pertier elements 93 and the cooling member 51 come into contact by means of the soft metal layer. Liquid metal having high thermal conductance may be used as the soft thermal conductance substance.

In the second embodiment, a plurality of (for example, four) first refrigerant passages 76 may be formed in the cooling member 51 at a portion corresponding to the first contact surface 74. Further, a plurality of (for example, two) second refrigerant passages 77 may be formed in the cooling member 51 at a portion corresponding to the first contact surface 75.

In the second embodiment, the second refrigerant passage 77 may be supplied with refrigerant that has been circulated through the first refrigerant passage 76. In such a structure, a temperature difference can be produced between the refrigerant circulated through the first refrigerant passage 76 and the refrigerant circulated through the second refrigerant passage 77.

In each of the first to third embodiments, the temperature sensors 55, 78, 79, and 87A to 87F may be arranged to detect the temperature of the contact surface 51A of the cooling member 51.

In each of the fourth and fifth embodiments, the temperature sensors 55, 78, 79, and 87A to 87F may be arranged to detect the temperature of the heat absorption surfaces 92 of the Pertier elements 93.

In each embodiment, at least part of the rear surface 41B of the mirror 41 may come into contact with the contact surface 51A of the cooling member 51.

In each of the first to third embodiments, the cooling member 51 may be fixed to the mirror 41 by, for example, a screw, so that the mirror 41 and the cooling member 51 are pressed to each other. In such a case, the screw serves as a fixing mechanism.

In the same manner, in each of the fourth and fifth embodiments, the cooling member 51 may be fixed to the mirror 41 by a screw with the Pertier elements 93 arranged in between.

In each of the fourth and fifth embodiments, the Pertier elements 93 may each be arranged between adjacent ones of the engagement mechanisms 52.

In each embodiment, the mirror 41 may be formed by a metal such as copper or stainless steel.

In each embodiment, a vacuum atmosphere is produced in the exposure apparatus. However, a vacuum atmosphere may be produced in only the barrels of the illumination optical system and the projection optical system. Further, the barrels may be filled with inert gas such as air, nitrogen, argon, krypton, radon, neon, xenon, and the like.

In each embodiment, an optical member cooling apparatus according to the present invention is embodied in an optical member cooling apparatus for cooling the mirror 41. However, the optical member cooling apparatus according to the present invention may also be embodied in an optical member cooling apparatus for cooling other optical members, such as a lens, a half mirror, a parallel planar plate, a prism, a prism mirror, a rod lens, a fly's-eye lens, and a phase difference plate.

In each embodiment, the optical member cooling apparatus is not limited to a structure for cooling the mirror in the illumination optical system of the exposure apparatus 20 and may be embodied in a structure for cooling, for example, the reticle 22. Furthermore, the optical member cooling apparatus may be embodied in a cooling structure for an optical member in an optical system for other optical machines, such as a microscope, an interferometer, or the like.

When the exposure light is in the ArF wavelength range, a reflective refraction type optical system may be used as the projection optical system. In such a case, the mirror cooling apparatus of the present invention may be applied to a mirror in an optical system of the reflection refraction type optical system.

Further, when the rear surface of the mirror has a curvature, the contact surface of the cooling member can be processed in accordance with the curvature.

Additionally, when the mirror includes an opening, the cooling member may be formed to surround the opening.

The exposure apparatus 20 of each embodiment may be applied to a liquid immersion exposure apparatus that uses as a liquid water (pure water), a fluorine liquid, and decalin (C₁₀H₁₈) or to an exposure apparatus having a predetermined gas (e.g., air or inert gas) filled between the projection optical system 25 and the wafer 24. The exposure apparatus is also applicable to an optical system for a contact exposure apparatus, which arranges a mask and a substrate in close contact with each other when exposing a pattern of the mask without using a projection optical system, and a proximity exposure apparatus, which arranges a mask and a substrate proximal to each other when exposing a pattern of the mask.

Furthermore, the exposure apparatus 20 of the present invention is not limited to an exposure apparatus of a reduction exposure type and may be an equal magnification exposure type or magnification exposure type exposure apparatus.

The present invention is applicable not only to an exposure apparatus that manufactures a micro-device such as a semiconductor device but also to an exposure apparatus for transferring a circuit pattern from a mother reticle to a glass substrate, a silicon wafer, or the like to manufacture a reticle or a mask used in a light exposure apparatus, an X-ray exposure apparatus, an electron beam exposure apparatus, or the like. A transmissive reticle is generally used in an exposure apparatus using DUV (Deep Ultra Violet), VUV (Vacuum Ultra Violet) light, or the like. Silica glass, silica glass doped with fluorine, fluorite, magnesium fluoride, crystal, or the like may be used as the reticle substrate. In a proximity type x-ray exposure apparatus, an electron beam exposure apparatus, or the like, a transmissive mask (stencil mask, membrane mask) is used, and silicon wafer or the like is used as the mask substrate.

Obviously, the present invention is also applicable not only to an exposure apparatus for manufacturing a semiconductor device but also to an exposure apparatus for manufacturing a display including a liquid crystal display device (LCD) or the like and transferring a device pattern onto a glass substrate, an exposure apparatus for manufacturing a thin-film magnetic head or the like and transferring a device pattern onto a ceramic wafer or the like, and an exposure apparatus for manufacturing an imaging device such as a CCD or the like.

Furthermore, the present invention may be applied to a scanning stepper that transfers a pattern of a mask onto a substrate in a state in which the mask and the substrate are relatively moved and sequentially step-moves the substrate, and a step-and-repeat type stepper that transfers a pattern of a mask onto a substrate in a state in which the mask and the substrate are still and sequentially step-moves the substrate.

The light source of the exposure apparatus 20 may be a g-ray (436 nm), an i-ray (365 nm), KrF excimer laser (247 nm), ArF excimer laser (193 nm), F₂ laser (157 nm), Kr₂ laser (146 nm), Ar₂ laser (126 nm), or the like. A harmonic wave in which single wavelength laser light of the infrared range or visible range oscillated from a DFB semiconductor laser or fiber laser is amplified with a fiber amplifier doped with, for example erbium (or both erbium and ytterbium), and wavelength converted to an ultraviolet light using a non-linear optical crystal may be used.

The exposure apparatus 20 of each embodiment is manufactured, for example, in the following manner.

First, the cooling member 51 of any of the above embodiments is fixed to at least one of the plurality of mirrors forming the illumination optical system and the projection optical system 25. The illumination optical system and the projection optical system 25 are arranged in the main body of the exposure apparatus 20 and then optical adjustments are performed. The wafer stage 27 (including the reticle stage 26 for a scan type exposure apparatus), which is formed by many mechanical components, is attached to the main body of the exposure apparatus 20. Then, wires are connected. After connecting a vacuum pipe for drawing out gas from the optical path of the EUV light EX, general adjustments (electrical adjustment, operation check, or the like) are performed.

Each component is assembled to the cooling member 51 after removing processing oil and impurities such as metal material by performing ultrasonic cleaning or the like. The manufacturing of the exposure apparatus 20 is preferably performed in a clean room in which the temperature, humidity, and pressure are controlled, and in which the cleanness is adjusted.

In each of the above embodiments, ZERODUR (registered trademark) is used as the material of the mirror 41. However, the cooling structure of the above embodiments may also be applied when using crystals such as fluorite, synthetic silica, lithium fluoride, magnesium fluoride, strontium fluoride, lithium-calcium-aluminum-fluoride, lithium-strontium-aluminum-fluoride, or the like; glass fluoride including zirconium-barium-lanthanum-aluminum; and modified silica such as silica glass doped with fluorine, silica glass doped with hydrogen in addition to fluorine, silica glass containing an OH group, silica glass containing an OH group in addition to fluorine can be used.

An embodiment of a manufacturing method for a device in which the exposure apparatus 20 described above is used in a lithography process will now be described.

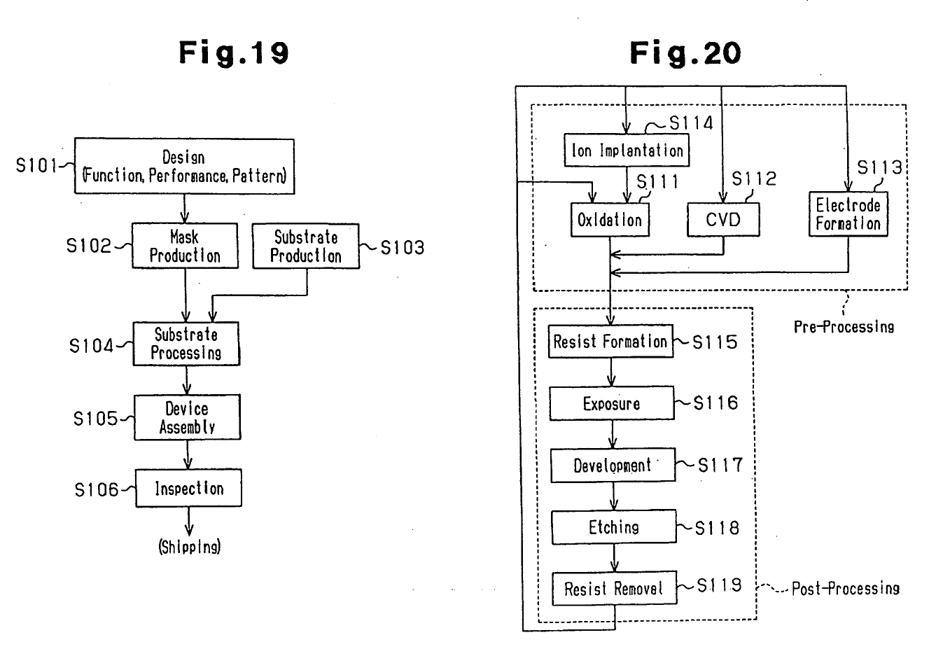

FIG. 19 is a flowchart illustrating an example for manufacturing a device (semiconductor device such as an IC and LSI, liquid crystal display device, imaging device (CCD or the like), thin-film magnetic head, micro-machine, or the like). As shown in FIG. 19, first, in step S101 (design step), a function/performance design (e.g., circuit design etc. of semiconductor device) for the device (micro-device) is performed, and a pattern design for realizing the function of the device is performed. Subsequently, in step S102 (mask production step), a mask (reticle R etc.) that forms the designed circuit pattern is produced. In step S103 (substrate production step), a substrate (wafer W when silicon material is used) is produced using material such as silicon, glass plate, or the like.

In step S104 (substrate processing step), the mask and substrate prepared in steps S101 to S103 are used to form an actual circuit or the like on the substrate through a lithography technique, as will be described later. In step S105 (device assembling step), device assembly is performed using the substrate processed in step S104. Step S105 includes the necessary processes, such as dicing, bonding, and packaging (chip insertion or the like).

Finally, in step S106 (inspection step), inspections such as an operation check test, durability test, or the like are conducted on the device manufactured in step S105. Upon completion of such processes, the device is completed and then shipped out of the factory.

FIG. 20 is a flowchart showing in detail one example of the procedures performed in step S104 of FIG. 19 in the case of a semiconductor device. As shown in FIG. 20, in step S111 (oxidation step), the surface of the wafer W is oxidized. In step S112 (CVD step), an insulating film is formed on the surface of the wafer W. In step S113 (electrode formation step), an electrode is formed on the wafer W by performing vapor deposition. In step S114 (ion implantation step), ions are implanted into the wafer W. Steps S111 to S114 described above are pre-processing operations for each stage of wafer processing and are selected and performed in accordance with the processing necessary in each stage.

In each wafer processing stage, when the above-described pre-processing ends, post-processing is performed as described below. In the post-processing, first in step S115 (resist formation step), a photosensitive agent is applied to the wafer W. Subsequently, in step S116 (exposure step), the circuit pattern of a mask (reticle R) is transferred onto the wafer W by the lithography system (exposure apparatus 20), which is described above. In step S117 (development step), the exposed wafer W is developed, and in step S118 (etching step), exposed parts where there is no remaining resist are etched and removed. In step S119 (resist removal step), unnecessary resist subsequent to etching is removed.

Repetition of the pre-processing and post-processing forms many circuit patterns on the wafer W.

In the above-described device manufacturing method of the present embodiment, the use of the exposure apparatus 20 in the exposure process (step S116) enables the resolution to be increased by the EUV light EX. Further, the exposure light amount can be controlled with high accuracy. As a result, devices with a high degree of integration and having a minimum line width of about 0.1 μm are manufactured at a satisfactory yield.

What is claimed is:

1. An optical member cooling apparatus for cooling an optical member, the optical member cooling apparatus comprising:
a cooling member including a contact surface which contacts a certain surface of the optical member; and
a fixing mechanism which fixes together the optical member and the cooling member in a state in which the certain surface and the contact surface of the cooling member are pressed against each other.

2. The optical member cooling apparatus according to claim 1, wherein the certain surface includes a first surface and a second surface that differs from the first surface, the optical member cooling apparatus further comprising:
a temperature adjustment device which independently controls the temperatures of the first surface and the second surface.

3. The optical member cooling apparatus according to claim 2, wherein the cooling member includes:
a first contact surface which contacts the first surface; and
a second contact surface which contacts the second surface.

4. The optical member cooling apparatus according to claim 2, wherein:
the cooling member includes a first cooling portion including a first contact surface which contacts the first surface and a second cooling portion including a second contact surface which contacts the second surface;
the first cooling portion and the second cooling portion are each fixed to the optical member by the fixing mechanism; and
the temperature adjustment device independently adjusts the temperatures of the first cooling portion and the second cooling portion.

5. The optical member cooling apparatus according to claim 1, wherein the certain surface and the contact surface of the cooling member contact each other by means of a soft heat transmission substance layer.

6. An optical member cooling apparatus for cooling an optical member, the optical member cooling apparatus comprising:
a heat transmission member including a heat absorption surface and a heat radiation surface and contacting the certain surface of the optical member with the heat absorption surface;
a cooling member including a contact surface which contacts the heat radiation surface of the heat transmission member; and
a fixing mechanism which fixes the heat transmission member and the cooling member to the optical member in a state in which the certain surface and the heat absorption surface are pressed against each other and the heat radiation surface and the contact surface are pressed against each other.

7. The optical member cooling apparatus according to claim 6, wherein the certain surface includes a first surface and a second surface that differs from the first surface, and the heat transmission member includes a first heat transmission member having a heat absorption surface contacting the first surface and a second heat transmission member having a heat absorption surface contacting the second surface, the optical member cooling apparatus further comprising:
a controller which independently controls heat transmission of the first heat transmission member and heat transmission of the second heat transmission member.

8. The optical member cooling apparatus according to claim 7, wherein the cooling member includes:
a first contact surface which contacts the heat radiation surface of the first heat transmission member; and
a second contact surface which contacts the heat radiation surface of the second heat transmission member.

9. The optical member cooling apparatus according to claim 7, wherein:
the cooling member includes a first cooling portion including a first contact surface which contacts the heat radiation surface of the first heat transmission member and a second cooling portion including a second contact surface which contacts the heat radiation surface of the second heat transmission member;
the first cooling portion and the second cooling portion are each fixed to the optical member by the fixing mechanism in a state in which the first heat transmission member and the second heat transmission member are arranged between the corresponding contact surfaces and the certain surface.

10. The optical member cooling apparatus according to claim 9, wherein:
a plurality of the first heat transmission members are arranged on the first surface; and
the first cooling portion is provided for each of the first heat transmission members.

11. The optical member cooling apparatus according to claim 9, wherein:
a plurality of the second heat transmission members are arranged on the second surface; and
the second cooling portion is provided for each of the second heat transmission members.

12. The optical member cooling apparatus according to claim 6, wherein the certain surface and the heat absorption surface contact each other by means of a soft heat transmission substance layer, and the heat radiation surface and the contact surface of the cooling member contact each other by means of a soft heat transmission substance layer.

13. The optical member cooling apparatus according to claim 5, wherein the soft heat transmission substance layer includes either one of a soft metal and an alloy.

14. The optical member cooling apparatus according to claim 1, wherein the certain surface is formed by a metal layer which is provided to the optical member and easier to machine than the material of the optical member.

15. The optical member cooling apparatus according to claim 1, wherein the contact surface is formed by a metal layer which is provided to the cooling member and easier to machine than the material of the cooling member.

16. The optical member cooling apparatus according to claim 1, wherein the fixing mechanism includes:
a first engagement portion arranged on the optical member and formed in the certain surface;
a second engagement portion arranged on the cooling member and engaged with the first engagement portion; and
a biasing member which biases the first engagement portion toward the second engagement portion.

17. The optical member cooling apparatus according to claim 16, wherein:
the second engagement portion includes a tip portion having a predetermined shape and a shaft having a shape that is smaller than the predetermined shape; and
the first engagement portion includes a groove, which is engageable with the tip portion and extends in a predetermined direction, and a fitting portion, which covers part of the groove and to which the shaft is fittable.

18. The optical member cooling apparatus according to claim 17, wherein the second engagement portion includes a flexure which connects the tip portion and the shaft.

19. The optical member cooling apparatus according to claim 16, wherein a plurality of the fixing mechanisms are arranged on the certain surface.

20. The optical member cooling apparatus according to claim 18, wherein:
the certain surface is formed on a surface opposite to an incident surface to which light strikes; and
a plurality of the fixing mechanisms are arranged on the certain surface in a region corresponding to the incident surface.

21. The optical member cooling apparatus according to claim 1, wherein:
the cooling member includes a refrigerant passage through which refrigerant for cooling the cooling member circulates.

22. The optical member cooling apparatus according to claim 2, wherein the cooling member includes a first refrigerant passage, through which refrigerant for cooling a portion corresponding to the first surface circulates, and a second refrigerant passage, through which refrigerant for cooling a portion corresponding to the second surface circulates.

23. The optical member cooling apparatus according to claim 21, further comprising:
a temperature sensor which detects the temperature of at least either one of the optical member and the cooling member, wherein the temperature of the refrigerant is adjusted based on the detection of the temperature sensor.

24. The optical member cooling apparatus according to claim 4, wherein:
the first cooling portion and the second cooling portion each include a refrigerant passage through which refrigerant for cooling the corresponding cooling portion circulates; and
the temperature adjustment device adjusts the temperature of the refrigerant in each cooling portion.

25. The optical member cooling apparatus according to claim 4, further comprising:
a temperature sensor provided to each cooling portion which detects the temperature of at least either one of the optical member and the cooling portion, wherein the temperature adjustment device adjusts the temperature of each cooling portion based on the detection of each temperature sensor.

26. The optical member cooling apparatus according to claim 7, further comprising:
a temperature sensor provided to each of the first heat transmission member and the second heat transmission member which detects the temperature of at least either one of the optical member and the heat absorption surface of the heat transmission member, wherein the controller independently controls the first heat transmission member and the second heat transmission member based on the detection of each temperature sensor.

27. The optical member cooling apparatus according to claim 1, wherein the optical member includes a mirror arranged in a vacuum atmosphere.

28. A barrel for holding a plurality of optical members, the barrel comprising:
an optical member cooling apparatus according to claim 1 provided to at least one of the optical members.

29. An exposure apparatus, including a plurality of optical members, for exposing a substrate with exposure light through a mask having a pattern, the exposure apparatus comprising:
an optical member cooling apparatus according to claim 1 provided to at least one of the optical members.

30. The exposure apparatus according to claim 29, wherein the exposure light includes extreme ultraviolet light or soft x-ray.

31. The exposure apparatus according to claim 29, wherein the plurality of optical members form an optical system which illuminates the mask having the pattern or an optical system which forms the pattern on the substrate.

32. A method for manufacturing a device, the method comprising:
a lithography process using an exposure apparatus according to claim 29.
